(19) United States
(12) Patent Application Publication
(10) Pub. No.: US 2014/0121997 A1
(43) Pub. Date: May 1, 2014

(54) METHOD FOR THE UNAMBIGUOUS DETECTION OF THE WEAR THRESHOLD OF A TYRE

(71) Applicant: Antoine Paturle, Clermont-Ferrand Cedex 9 (FR)

(72) Inventor: Antoine Paturle, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/126,141

(22) PCT Filed: Jun. 15, 2012
(86) PCT No.: PCT/FR2012/051339

§ 371 Date: Jan. 16, 2014

(30) Foreign Application Priority Data
Jun. 15, 2011 (FR) 1155236

(51) Int. Cl. G01M 17/02

(52) U.S. Cl. CPC G01M 17/02
USPC 702/34

(57) ABSTRACT

The wear detection method applies to a tyre (10) comprising NEᵢ set(s) of acoustic wear indicators associated with at least two wear thresholds (S₁, S₂, S₃, S₄, S₅, S₆) so as to generate an acoustic fingerprint noise, at least when each threshold (S₁, S₂, S₃, S₄, S₅, S₆) has been exceeded. Each indicator of each set is substantially axially aligned with each other indicator of the set.

For each threshold Sᵢ, kₘᵢₙ is the minimum value of the values of kᵢ for iε[2, M] where M is the total number of wear thresholds, with:
kᵢ=NEᵢ/NEᵢ₋₁ when for the value of iε[2, M], NEᵢ/NEᵢ₋₁>1, or
kᵢ=NEᵢ₋₁/NEᵢ when for the value of iε[2, M], NEᵢ₋₁/NEᵢ>1

For each threshold Sᵢ, the acoustic fingerprint noise is detected at a speed V. The value of the speed V is limited to an interval I=[Vₘᵢₙ; Vₘₐₓ] satisfying Vₘₐₓ≦kₘᵢₙ·Vₘᵢₙ.

The present invention relates to a method for detecting tyre wear. It is notably applicable to tyres for vehicles of any type, passenger vehicles or heavy goods vehicles.

As a tyre runs along the ground, its tread that is contact with the ground is worn away through friction. To make it easier to monitor tyre wear and to detect excessive wear, tyres are fitted with wear indicators, notable acoustic ones, that allow the user to detect several wear thresholds.

For each threshold, the acoustic wear indicators generate an acoustic fingerprint noise that has noticeable characteristics, notably frequency characteristics. These frequency characteristics are dependent on parameters including, amongst others, the number of wear indicators, their distribution, the rotational speed of the tyre and the size of the tyre. Thus, for certain values of these parameters, the characteristics of the noise generated by the indicators associated with different thresholds are identical, which means that it is impossible to determine which wear threshold has been reached.

It is an object of the invention to provide a method that allows unambiguous identification of which wear threshold has been reached.

To that end, one subject of the invention is a method for detecting the wear of a tyre, comprising:

at least two wear thresholds,

for each wear threshold Sᵢ, NEᵢ set(s) of at least one acoustic wear indicator associated with this threshold Sᵢ so as to generate an acoustic fingerprint noise at least when the threshold Sᵢ has been exceeded, the number of set(s) of acoustic wear indicator(s) associated with each threshold being different from the number of sets of acoustic wear indicator(s) associated with each other threshold, each indicator of each set being substantially axially aligned with each other indicator of the set when this set comprises at least two indicators, in which method:

for each threshold Sᵢ, kₘᵢₙ is the minimum value of the values of kᵢ for iε[2, M] where M is the total number of wear thresholds, with:

kᵢ=NEᵢ/NEᵢ₋₁ when for the value of iε[2, M], NEᵢ/NEᵢ₋₁>1, or

kᵢ=NEᵢ₋₁/NEᵢ when for the value of iε[2, M], NEᵢ₋₁/NEᵢ>1

for each threshold Sᵢ, the acoustic fingerprint noise generated by the indicator or indicators associated with this threshold at a speed V is detected, and

the value of the speed V for the detection of the acoustic fingerprint noise is limited to an interval I=]Vₘᵢₙ; Vₘₐₓ] satisfying Vₘₐₓ≦kₘᵢₙ·Vₘᵢₙ.

Thus, tyre wear is detected only when the speed V of this tyre is within a suitable range of speeds.

The method according to the invention allows a user of the tyre to be alerted and to identify the wear level reached irrespective of the values of the parameters listed hereinabove.

In the present application, the acoustic fingerprint noise generated by the indicators is the acoustic signature of the indicators. This noise may also be considered to be the acoustic fingerprint of the indicators.

Specifically, the noise generated by the acoustic wear indicator or indicators associated with each threshold is characteristic of this threshold, notably because of the number of indicators associated with each threshold and because of the way in which these indicators are distributed. In such a method, it is implicit that the number of set(s) of acoustic wear indicator(s) associated with each threshold is different from the number of set(s) of acoustic wear indicator(s) associated with each other threshold. In the interval I, the characteristics, notably frequency characteristics, of the noise generated by the sets of indicators associated with two different thresholds cannot be identical. Thus one unique wear threshold is associated with certain values of the characteristics, notably the frequency characteristics, of the noise. For example, once Vₘᵢₙ is determined and knowing kₘᵢₙ, it is possible to determine Vₘₐₓ and therefore I for unambiguous detection. Conversely, once Vₘₐₓ is determined and knowing kₘᵢₙ, it is possible to determine the Vₘᵢₙ and therefore I for unambiguous detection. For any value V contained within the interval I, it is therefore possible unambiguously to identify the wear threshold reached. For preference, the value of the speed V for the detection of the acoustic fingerprint noise is limited (the speed V is chosen) to an interval I=[Vₘᵢₙ; Vₘₐₓ] satisfying Vₘₐₓ<kₘᵢₙ·Vₘᵢₙ.

The indicators associated with the various thresholds have a special shape that gives them acoustic properties, which means to say that these indicators cause a characteristic noise when the worn tyre is running.

For each indicator associated with each threshold, the characteristic noise begins only when the tyre has been worn beyond the corresponding threshold. Each indicator associated with a threshold thus forms a wear indicator that is acoustic when said threshold has been exceeded.

Thus, even if the driver does not regularly perform a visual inspection of the surface condition of his tyres, he will be informed of the crossing of each threshold when, while driving, the acoustic fingerprint noise is detected.

For preference, use is made of a processing unit and of one or more microphones for detecting the running noises, these being connected to the processing unit able to detect the noise from the running noise, to inform the driver that his tyres are worn and to identify the wear threshold reached.

It will be understood that speed here means the linear rotational speed of the tyre which is substantially equal to the speed of the vehicle fitted with the tyre.

Each acoustic wear indicator is different from an acoustic cavity, notably from an acoustic cavity that is such that, beyond each threshold, each acoustic cavity opens radially to the outside of the tyre and is configured so that it is closed off in a substantially airtight manner by the ground as it passes through the contact area in which the tyre makes contact with the ground. Such acoustic cavities are described in publication FR 2 937 902.

Advantageously, the acoustic fingerprint noise comprises several elementary acoustic fingerprint frequency components, preferably forming at least part of a Dirac comb.

The elementary frequency components of the acoustic fingerprint noise are characteristic of the noise generated by the indicators. Thus, when each tyre wear threshold is reached, the acoustic fingerprint noise emitted by the indicators contains several elementary frequency components which are spread in the frequency domain. Further, such an acoustic fingerprint noise has a comb pattern of elementary frequency components that is noticeable, unique and therefore easy to detect.

According to other optional features of the method, each elementary frequency component of the acoustic fingerprint noise is separated from at least one adjacent elementary frequency component of the acoustic fingerprint noise by a frequency difference contained within a reference frequency interval associated with just one of the thresholds. For each threshold, the reference frequency interval is characteristic of this threshold. Thus, when a wear threshold is reached, the acoustic fingerprint noise emitted by the indicators associated with that threshold contains several elementary frequency components distributed in the frequency domain according to the predetermined pattern. The reference frequency interval is predetermined and corresponds to all of the frequency differences that may separate the elementary frequency components of the noises associated with each wear threshold. Thus, this reference frequency interval covers all the frequency differences that may separate two elementary frequency components of the noises associated with each different wear threshold. In the speed interval I, the frequency difference separating two elementary frequency components of the noise is therefore associated with one unique wear threshold.

The reference frequency interval is predetermined and contained between 1 and 300 Hz. This frequency interval contains the frequency difference likely to separate the elementary frequency components of the noise emitted by the indicators. The reference frequency interval is determined by taking account of the extreme values of the parameters that one does not wish to have input or changed, for example the size of the tyre. Thus, for a passenger vehicle, for a speed in the range 10 to 130 km/h, a number of indicators in the range 1 to 20 and a circumference in the range 1.30 m to 3.0 m, the frequency difference of the elementary frequency components of the noise emitted by the indicators belongs to the interval contained between 1 Hz and around 300 Hz. A similar range of frequencies applies to heavy goods vehicles running at speeds of below 90 km/h, fitted with tyres having a maximum of 32 indicators and a circumference in the range 2.1 to 3.7 m.

The number of sets of acoustic wear indicators corresponding to a determined wear threshold is generally between 2 and 30. It is preferably at most 10 and highly preferably 8 to 10 sets for a passenger vehicle. It is generally 22 at most and preferably 12 to 20 sets for a utility heavy goods vehicle. As an option, just one wear indicator is used per set, so that the number of wear indicators is then preferably between 2 and 20.

In one embodiment, each set therefore comprises just one indicator.

In another embodiment, each set comprises at least two indicators.

In this embodiment, an indicator of a set associated with a threshold has substantially the same azimuth position as that of another indicator of the set associated with the same threshold. Thus, these indicators create sound simultaneously.

In another embodiment, two axially aligned indicators are associated with two different thresholds. In that case, the two indicators do not form part of the same set.

As an option, the set or sets of indicator(s) associated with each threshold is (are) evenly circumferentially distributed about the tyre (10).

What is meant by “sets that are evenly circumferentially distributed” is that each set of indicator(s) associated with a given threshold is situated substantially the same angular distance from the two sets of indicator(s) associated with this threshold and adjacent to it. In other words, the evenly distributed sets of indicator(s) associated with a given threshold have the same angular separation one from the next. When just one set is associated with a given threshold, this single set is also evenly circumferently distributed. Specifically, in this case, the adjacent sets are formed by this same set.

Further, as the sets of indicator(s) are evenly circumferentially distributed about the tread of the tyre whatever the threshold reached, the noises emitted once each threshold has been exceeded have frequency characteristics which are unique and noticeable. Specifically, spectral analysis of the noise emitted once each threshold has been exceeded reveals, in the frequency domain, a Dirac comb that can easily be identified from all the parasitic noises such as the road noise of the tyre, the wind, the engine noise or the associated drive train noise. To do that, use may be made of a wear detection method described in application PCT/FR2010/052584. As an alternative, other methods may be used.

The indicators may be axially offset from one another while at the same time being evenly circumferentiallly distributed about the tread.

Advantageously, each indicator consists of a projection of rubber extending radially from the bottom of a circumferential groove of the tyre, the projection being designed so that it comes into contact with the ground as it passes through the contact area in which the tyre makes contact with the ground once the threshold associated with the indicator has been exceeded.

Surprisingly, the inventors of the invention discovered that the projections are sufficient to give rise to a characteristic noise when the tyre is running after the wear threshold has been exceeded. The inventors would suggest that this noise is generated by at least two distinct physical phenomena which have a synergistic effect. On the one hand, once the wear threshold has been reached, the noise is generated by the impact of the projection on the ground. On the other hand, once the wear threshold has been reached, as the tyre runs along the ground, a plug of air is likely to be formed in the groove ahead of the projection because of the high relative speed between the tyre and the air through which the tyre is moving. Air is therefore temporarily trapped in a space confined between this plug and the projection as this space passes through the contact area in which the tyre is in contact with the ground. Through the effect of the deformation of the tyre in the contact area, this air trapped in this space is compressed and suddenly expands as it leaves the contact area when the tread breaks contact with the ground at the rear of the tyre.

Because each wear indicator consists of a single projection rather than of two projections forming a cavity closed to air as it passes through the contact area in which the tyre is in contact with the ground, for the same number of wear indicators the number of projections arranged in the groove or grooves is halved. The potential loss of performance generated by the projections is thus limited. There is therefore relatively little impact on the grip performance of the tyre.

Because the projections are arranged in the grooves, the noise emitted as a result of the projections is amplified by comparison with acoustic wear indicators positioned elsewhere in the tread. The emitted noise is amplified by a flared resonator formed by the tyre and the ground once the acoustic wear indicator has passed through the contact area. This amplification through a flared-resonator effect is at a maximum when the projections are preferably arranged axially in a central part of the tread. The central part of the tread means the region in the tread that extends axially, i.e. parallel to the axis of rotation of the tyre, over substantially half the width of this tread under nominal load and pressure conditions and that is centred relative to the central median plane of the tyre.

The circumferential width of a rubber projection is generally between 2 and 15 mm (millimetres) and preferably between 3 and 10 mm. These values are suitable for generating sufficient road noise.

The rubber projections may, transversely, extend over just part of the width of a circumferential groove. In that case, the removal of water contained in a circumferential groove is enhanced.

However, it has been found that the acoustic effect generated by a rubber projection is notably greater when this rubber projection extends transversely across the entire width of a circumferential groove. When this rubber projection comes into contact with the ground (the tyre being worn at least down as far as the corresponding wear threshold), the circumferential groove is closed by the ground at the rubber projection, thereby delimiting an upstream and a downstream space of this groove which do not communicate with one another at the rubber projection. It is observed that this notably increases the acoustic effect.

According to a first embodiment of the wear indicators, the tyre has no cavity delimited by two ribs which are formed transversely to the bottom of a groove, of predetermined height when the tyre is new, substantially equal to the difference between the predetermined depth of the groove and one of the predetermined wear thresholds, the distance separating the two ribs being less than a distance that is predetermined such that when the wear exceeds one of the wear thresholds or each wear threshold, the cavity formed by the groove and the two ribs becomes an acoustic cavity. The indicators may for example all consist of a rubber projection.

According to a second embodiment, the tyre may comprise, in addition to the rubber projections, other indicators, for example for a determined wear threshold, consisting of acoustic cavities having two transverse ribs, as described hereinabove.

For preference, the projections are arranged in such a way that, regardless of the degree of wear of the tyre (10), two circumferentially successive projections of one and the same groove and the groove delimit a space that is open to the air as the two projections pass through the contact area in which the tyre is in contact with the ground.

As an option, when the tyre is new, each circumferential groove has a predetermined depth and the height of each projection of each indicator is substantially equal to the difference between the predetermined depth of the groove and the threshold associated with the indicator.

One or all of the projections may be solid, i.e. without a cavity.

Alternatively, one or each projection comprises at least one cavity formed in the projection, the cavity being shaped in such a way that, when the threshold associated with the indicator comprising the projection has been exceeded, it:

opens radially to the outside of the tyre, and

is closed by the ground in a substantially airtight manner as it passes through the contact area in which the tyre is in contact with the ground.

Such a cavity typically does not extend as far as the bottom of the circumferential groove. Its volume is typically notably less than 250 mm³ (millimetres cubed), for example less than 150 mm³.

Such a cavity is, however, an acoustic cavity. The noise it generates, although limited, combines with the noise generated by the projections and produces a noise that is amplified in comparison with a projection that has no cavity.

Further, the cavity allows the first threshold projection to be distinguished visually from the legal wear indicator.

Finally, such a cavity does not penalize tyre performance or make the tyre more complicated to design.

In one embodiment, each projection of each indicator associated with a threshold is circumferentially separated from each projection of each indicator associated with each other threshold.

In another embodiment, each projection of each indicator associated with a threshold is immediately adjacent to a projection of an indicator associated with another threshold, which has the advantage that these two projections do not between them define a closed cavity likely to interfere with detection of the expected noise.

Furthermore, the number of locations for the first-threshold and second-threshold projections is reduced. The wear indicators therefore have little if any impact on the grip performance of the tyre.

When a projection corresponding to a determined wear threshold is not immediately adjacent to another projection it typically also constitutes a wear indicator for the higher wear thresholds. By contrast, if a projection is immediately adjacent to another threshold corresponding to a higher wear threshold, when the latter wear threshold is reached the two immediately adjacent projections then form just one single projection, thus acting as a single wear indicator corresponding to that threshold (rather than as two juxtaposed indicators).

In one embodiment, kₘᵢₙ=2.

According to optional features of the invention, the interval I is chosen from the following speed intervals in km/h: [50; 100], [60; 120] and [65; 130].

In an embodiment referred to as having a “descending” acoustic pattern, kᵢ=NEᵢ/NEᵢ₋₁>1 for any value of iε[2, M].

In other words, the number NEᵢ of sets of acoustic indicators increases with tyre wear.

In this embodiment, by increasing the number of sets and therefore the number of indicators, as the tyre becomes more worn the noise emitted by the indicators can then be detected more easily.

In an alternative form of this embodiment, each indicator associated with a given threshold is also associated with the threshold above the given threshold. That makes it possible to minimize the number of indicators that appear at each threshold. Thus, the effect that the indicators have on tyre performance, notably hydrodynamic performance, is minimized. Thus, each indicator associated with a given threshold is also associated with all the thresholds above the given threshold. This feature obviously does not apply to the indicators of the highest threshold.

In another alternative form, the indicator or indicators associated with a given threshold comprise(s) some of the indicators associated with the threshold below the given threshold and the indicators that appeared beyond the given threshold. Thus, only a few indicators associated with the lower threshold are also indicators associated with the given threshold.

In another alternative form of this embodiment, the acoustic indicator or indicators associated with a given threshold comprise(s) just some of the acoustic indicators associated with a threshold below a given threshold. This may notably be the case where, for immediately adjacent projections, there is just one single indicator corresponding to the uppermost threshold.

In general, the following method steps are performed:

a signal of the acoustic fingerprint noise of the tyre at the speed V is acquired,

a Fourier transform is applied to the signal in order to obtain a raw frequency spectrum,

this raw frequency spectrum is processed to obtain a filtered frequency spectrum containing equally distributed elementary frequency components in which each component is separated from the adjacent frequency component by a substantially constant frequency difference,

the wear threshold reached is identified unambiguously from this frequency difference.

Typically:

for each wear threshold the frequency difference of the frequency spectrum that corresponds to the acoustic fingerprint noise is predetermined for each value Vₘᵢₙ, Vₘₐₓ of the interval I in order to obtain a frequency difference band corresponding to this threshold,

wear is detected only when the tyre is at a speed V such that each frequency difference band of each threshold is separated from the frequency difference band or bands of each other threshold.

For preference, Vₘₐₓ<0.99·kₘᵢₙ·Vₘᵢₙ, and very preferably Vₘₐₓ<0.9·kₘᵢₙ·Vₘᵢₙ, In this way, the frequency difference bands corresponding to the various thresholds are clearly distinct and even spaced apart.

Another subject of the invention is a computer program, comprising code instructions for running the steps of the method as defined hereinabove when run on a computer.

A further subject of the invention is a medium on which to record data and comprising, in recorded form, a program as defined hereinabove.

Another subject of the invention is the provision of a program as defined hereinabove on a telecommunications network so that it can be downloaded.

The invention will be better understood from reading the description which will follow, which is given solely by way of non-limiting example, with reference to the drawings in which:

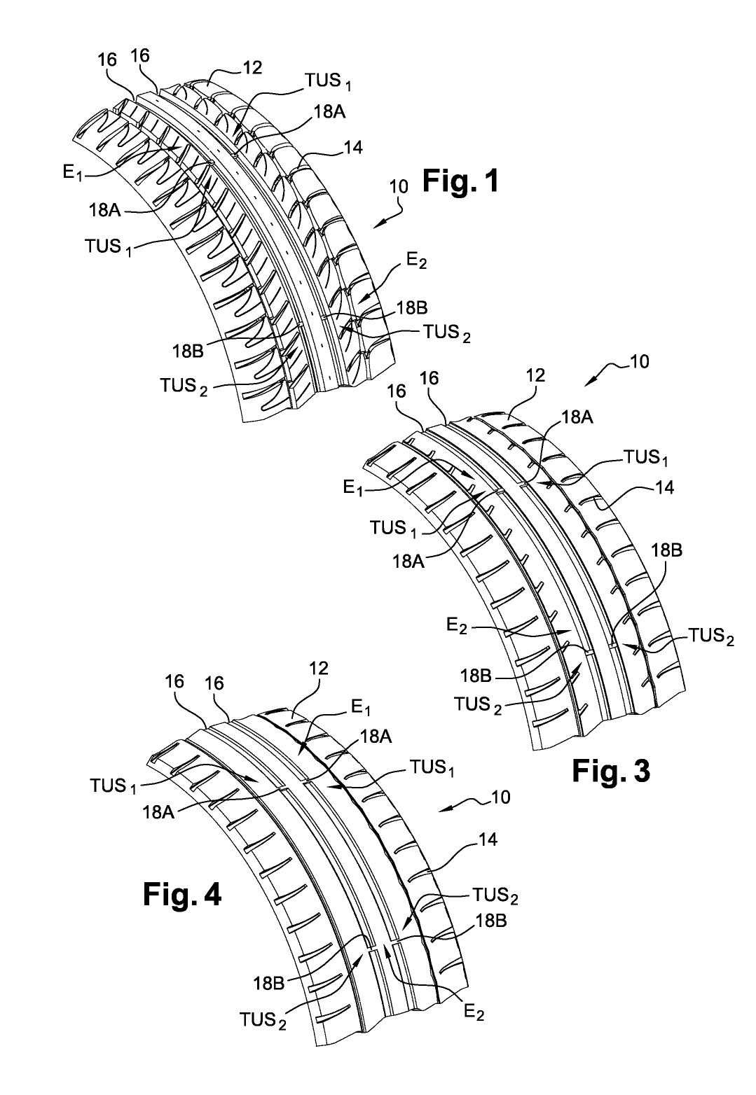

FIG. 1 is perspective view of a new tyre tread with a “descending” pattern according to a first embodiment;

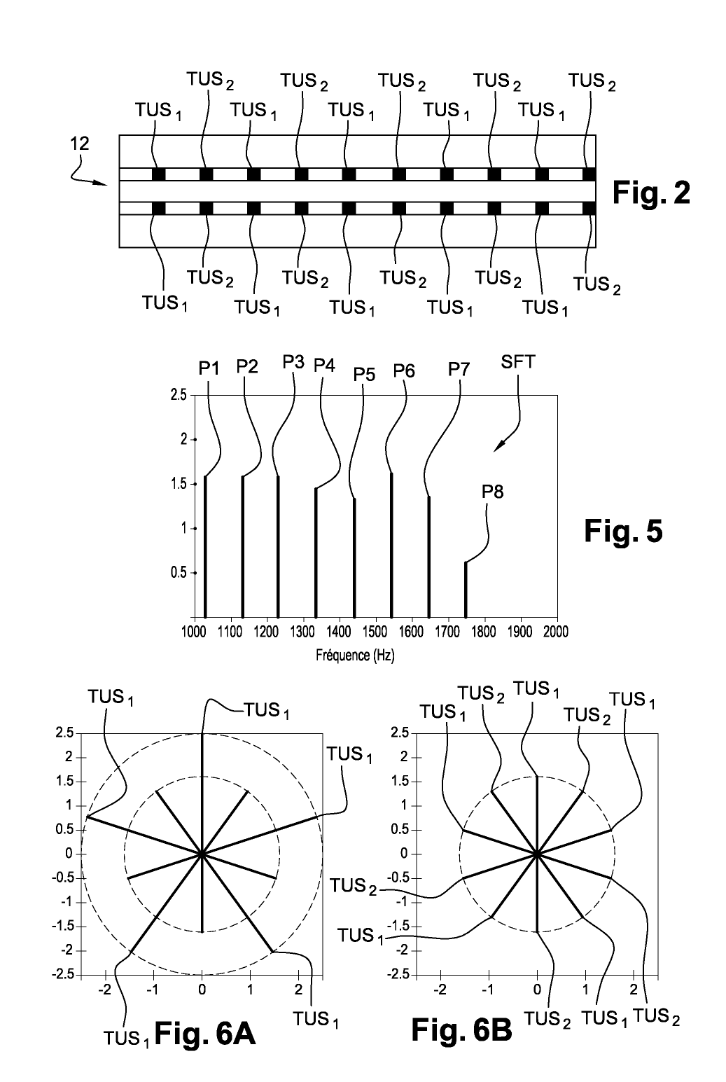

FIG. 2 schematically illustrates a developed tread of the tyre of FIG. 1;

FIGS. 3 and 4 are perspective views of the tread of the tyre depicted in FIG. 1 worn beyond first and second wear thresholds respectively;

FIG. 5 illustrates a frequency spectrum of the acoustic fingerprint noise of the indicators of the tyre of FIG. 3;

FIGS. 6A and 6B schematically illustrate the distribution of the sets of acoustic indicators of the tyre of FIGS. 1 to 4;

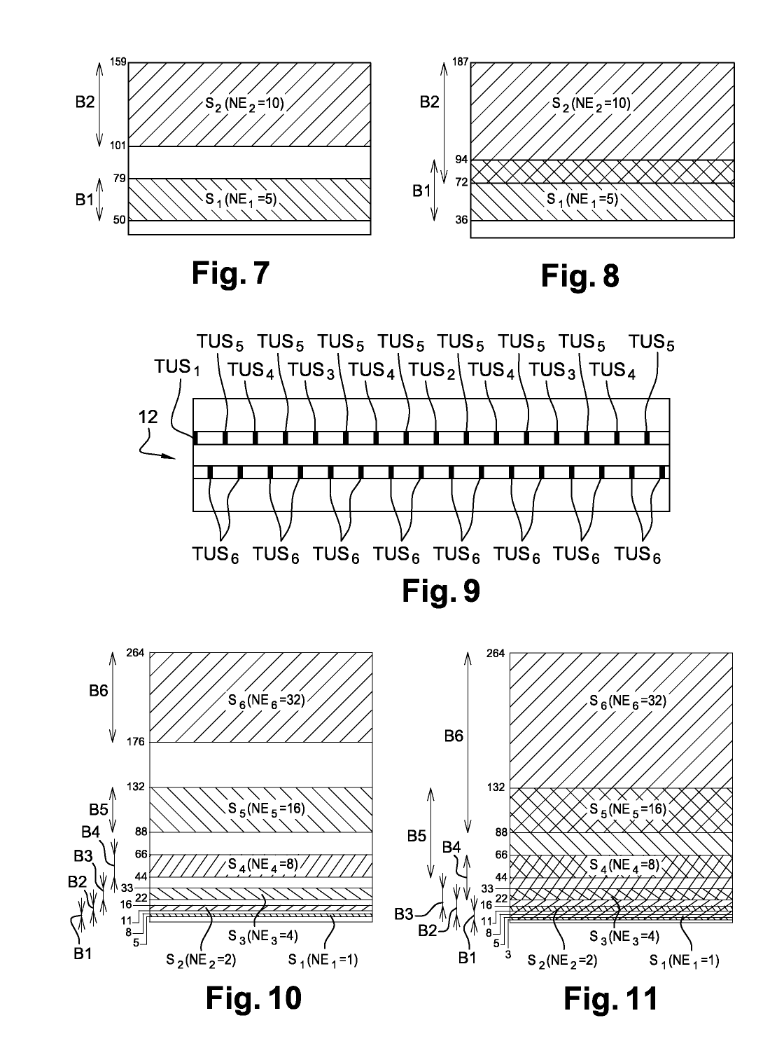

FIGS. 7 and 8 depict frequency bands of the noises generated by the various indicators associated with the various thresholds of the tyre of FIGS. 1 to 4 and 6A et 6B;

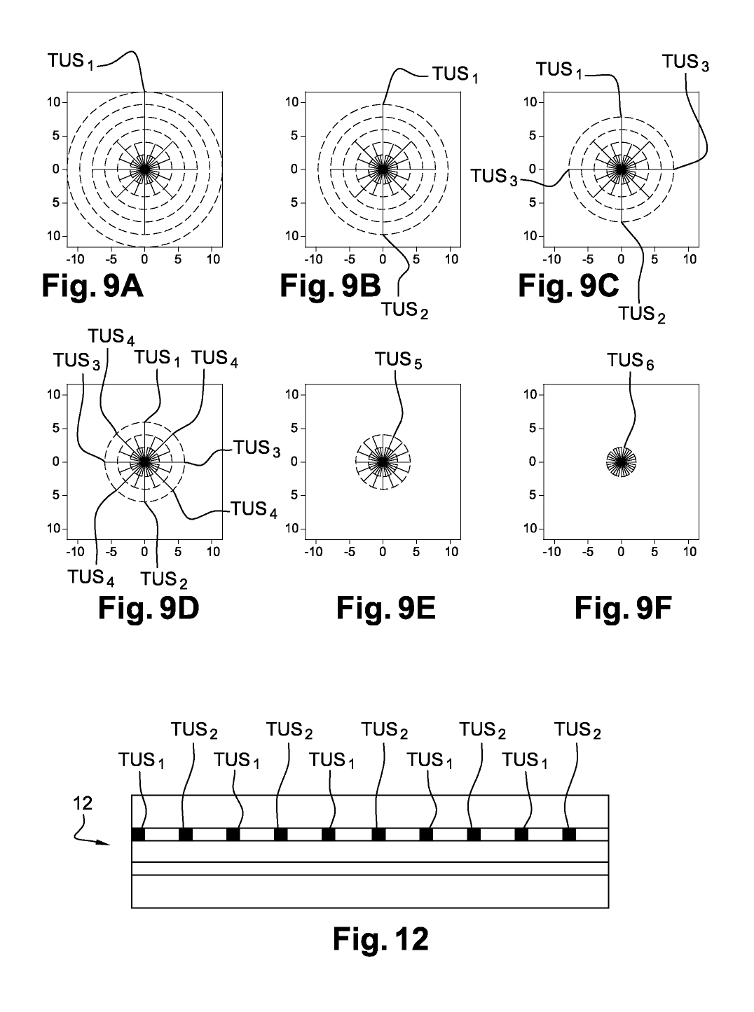

FIG. 9 schematically illustrates a developed tread of a tyre with a “descending” acoustic pattern according to a second embodiment;

FIGS. 9A to 9F schematically illustrate the distribution of the sets of acoustic indicators of the tyre of FIG. 9;

FIGS. 10 and 11 depict frequency bands of the noises emitted by the various indicators associated with the various thresholds of the tyre of FIGS. 9A to 9F;

FIG. 12 schematically illustrates a developed tread of a tyre according to a third embodiment;

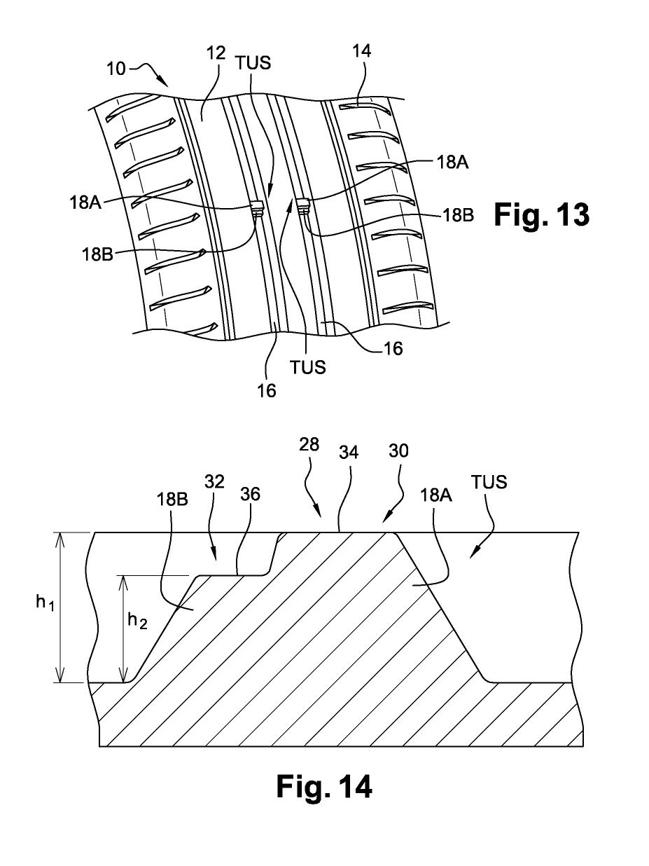

FIG. 13 is a view similar to that of FIG. 1 of a tyre according to a fourth embodiment of the invention;

FIG. 14 is a view in axial section in a plane passing through a groove of a tread of the tyre of FIG. 13 which has been worn down to a first wear threshold;

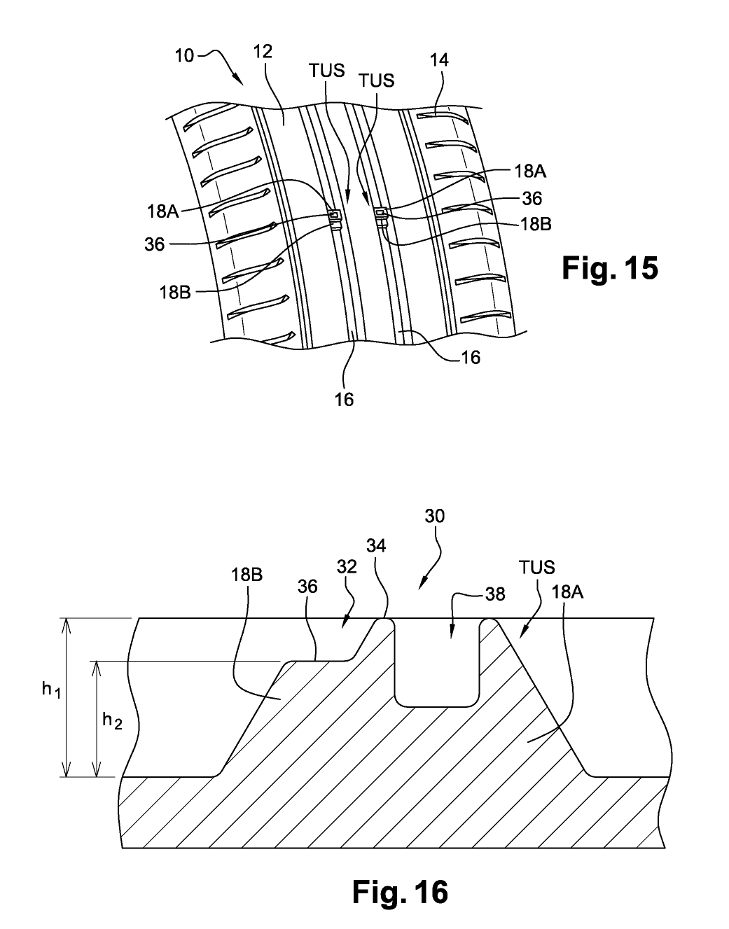

FIG. 15 is a view similar to that of FIG. 1 of a new tyre according to a fifth embodiment of the invention which has worn down to a first wear threshold;

FIG. 16 is a view in axial section in a plane passing through a groove of a tread of the tyre of FIG. 15.

FIG. 1 depicts a tyre according to a first embodiment of the invention, denoted by the general reference 10. The tyre 10 is intended for a passenger vehicle. The tyre 10 is substantially of revolution about an axis.

The tyre 10 comprises a tread 12 of substantially toroidal shape, the external surface of which has tread patterns 14. In particular, the tread 12 comprises two circumferential and parallel grooves 16 cut into the surface of the tyre, having a predetermined depth H when the tyre 10 is new. The depth H of these grooves 16 is of the order of 8 mm and their width of 10 mm. The tyre 10 comprises visual wear indicators (not illustrated) indicating the minimum legal tread depth threshold SL for the tyre. The depth of each groove corresponding to the threshold SL is set at 1.6 mm, which corresponds to a threshold SL=6.4 mm.

The tyre 10 comprises sets E₁, E₂, of acoustic wear indicators TUS. Each indicator TUS consists of a rubber projection 18 extending radially from the bottom of one of the grooves 16. The tyre 10 comprises two types of indicator TUS denoted TUS₁, TUS₂ and each respectively associated with at least one predetermined radial wear threshold S₁, S₂ of the tyre so as to generate an acoustic fingerprint noise at least when one of the thresholds S₁, S₂ has been exceeded. In this particular instance, each indicator TUS₁ associated with the threshold S₁ is also associated with the threshold S₂ so as to generate an acoustic fingerprint noise when the two thresholds S₁, S₂ have been exceeded. Each indicator TUS₂ is associated only with the threshold S₂ so that it generates an acoustic fingerprint noise when the threshold S₂ only has been exceeded.

Each indicator TUS₁, TUS₂ consists respectively of a projection 18A, 18B which is also associated with at least one predetermined tyre wear threshold S₁, S₂. Each projection 18A, 18B has respectively a first and a second predetermined height h₁, h₂ when the tyre is new. h₁>h₂ and S₂>S₁ so that each projection 18A is associated with the thresholds S₁ and S₂ and each projection 18B is associated only with the threshold S₂.

The tyre has no cavity delimited by two ribs formed transversely at the bottom of a groove, of predetermined height when the tyre is new, substantially equal to the difference between the predetermined depth of the groove and one of the predetermined wear thresholds, the distance separating the two ribs being less than a predetermined distance so that when one or each of the wear thresholds is exceeded, the cavity formed by the groove and the two ribs becomes an acoustic cavity.

The threshold S₂ is reached after the threshold S₁. In other words, the threshold S₂ represents more advanced wear than the threshold S₁. The threshold S₂ is reached when the tyre wear is greater than the wear when the threshold S₁ is reached. The first threshold S₁ corresponds substantially to 90% of the threshold SL, i.e. h₁=2.5 mm and S₁=5.5 mm. The second threshold S₂ corresponds substantially to 100% of the threshold SL, i.e. h₂=1.6 mm and S₂=6.4 mm.

Thus, in this embodiment, the first threshold S₁ corresponds to wear beyond which the tyre displays performance that could be impaired on a wet road surface. The second threshold S₂ meanwhile corresponds to wear beyond which the tyre no longer meets the legal requirements.

The thresholds S₁, S₂ are depicted schematically in FIGS. 6A-6B. FIG. 6A depicts the tyre 10 when it has reached the first wear threshold S₁ but has not yet reached the second wear threshold S₂. FIG. 6B depicts the tyre 10 when it has reached the second wear threshold S₂.

FIG. 2 depicts a developed diagram of the tread of the tyre of FIG. 1.

Each set E₁ of indicators TUS₁ comprises two projections 18A and each set E₂ of indicators TUS₂ comprises two projections 18B. Each projection 18A, 18B respectively of each set E₁, E₂ is substantially axially aligned with a respective one of each other projection 18A, 18B of the same set E₁, E₂ respectively.

The respective sets E₁-E₂ of indicators TUS₁-TUS₂ associated with each respective threshold S₁, S₂, in this instance the projections 18A-18B, are evenly circumferentially distributed about the tyre 10. Thus, first, the sets of projections 18A are evenly circumferentially distributed about the tyre 10 and, second, the sets of projections 18B are evenly circumferentially distributed about the tyre 10.

Moreover, all the sets of projections 18 are evenly circumferentially distributed about the tyre 10. Thus, when each corresponding threshold S₁, S₂ is exceeded, as the tyre rotates, the projections 18A, 18B come into contact with the ground at constant time intervals when the tyre is running at a substantially constant speed.

The tyre 10 comprises NE₁=5 sets E₁ of two indicators TUS₁ and NE₂=10 sets E₂ of two indicators TUS₁, TUS₂.

FIGS. 6A-6B schematically indicate the indicators TUS₁, TUS₂ using lines. These lines run radially over a radial portion and between them schematically indicate the thresholds between which the corresponding indicators TUS₁, TUS₂ are acoustic.

When the tyre is new, as indicated in FIG. 1, the height of the projections 18A, 18B is smaller than the depth of the grooves 16 so that each indicator TUS₁, TUS₂ has a space above the projections 18A, 18B, i.e. at the top of the projections 18A, 18B. Thus, even when the tread is in contact with flat, smooth ground, the ground does not come into contact with the projections 18A, 18B.

FIG. 3 depicts the tyre of FIG. 1 when it is worn beyond the threshold S₁. In other words, this is a tyre which has run a great many kilometres and the tread 12 of which has progressively been worn down until it has lost a few milllimetres. This tyre 10 is also depicted schematically in FIG. 6A which shows that, beyond the threshold S₁, the tyre 10 has NE₁=5 sets of two indicators TUS₁.

In this particular instance, the wear of the tread 12 of the tyre 10 as indicated in FIG. 2 is 6 mm, i.e. beyond the threshold S₁ or, in other words, greater than the distance which, when the tyre 10 is new, separates the tops of the projections 18A from the surface of the tread 12. Bearing in mind the wear in excess of S₁, the top of the projections 18A is now at the same level as the surface of the tread 12.

Tyre wear is below the threshold S₂, or in other words less than the distance which, when the tyre 10 is new, separates the top of the projections 18B from the surface of the tread 12. The top of the projections 18B is at a level lower than that of the tread at this stage of wear.

Beyond the threshold S₁, each projection 18A has a depth less than the height h₁. Here, the depth is less than 2.5 mm and measures 2 mm for wear of 6 mm. The height of each projection 18A is therefore equal to its depth. This height or depth is equal to the difference between the depth of each groove 16 and the wear of the tyre 10.

Each projection 18A is arranged in such a way as to come into contact with the ground as it passes through the contact area in which the tyre is in contact with the ground when the threshold S₁ has been exceeded.

FIG. 3 depicts the tyre 10 of FIGS. 1 and 2 when it has been worn beyond the threshold S₂. This tyre 10 is also schematically depicted in FIG. 6B which shows that the tyre 10 comprises NE₂=10 sets of two indicators TUS₁, TUS₂.

In this particular instance, the wear of the tread 12 of the tyre 10 indicated in FIG. 3 is 7 mm, i.e. greater than the threshold S₂, but also greater than the threshold S₁ or, in other words, greater than the distance which, when the tyre 10 is new, separates the tops of the projections 18B from the surface of the tread 12. Given the wear in excess of S₂, the tops of the projections 18B, and also those of the projections 18A, are at the same level as the surface of the tread 12.

Once the threshold S₂, has been exceeded, each projection 18B has a depth less than the height h₂. Here, the depth is less than 1.6 mm and measures 1 mm for wear of 7 mm. The height of each projection 18A, 18B is therefore equal to its depth. This height or depth is equal to the difference between the depth of each groove 16 and the wear of the tyre 10.

Each groove 18A, 18B is arranged so that it comes into contact with the ground as it passes through the contact area in which the tyre is in contact with the ground when the threshold S2 has been exceeded.

The indicators TUS₁, TUS₂ are arranged in such a way as to generate acoustic fingerprint noises when the respective thresholds S₁, S₂ have been exceeded, and are described as “acoustic” indicators. In the example illustrated, the numbers NEᵢ, NEᵢ₋₁ of sets of indicators respectively associated with two consecutive thresholds Sᵢ, Sᵢ₋₁ satisfy NEᵢ₋₁<NEᵢ for iε[2, M] where M is the total number of wear thresholds and the threshold Sᵢ is greater than the threshold Sᵢ₋₁.

Therefore, for each value of iε[2, M], kᵢ=NEᵢ/NEᵢ₋₁ because NEᵢ/NEᵢ₋₁>1. Thus, a tyre in which NE₂>NE₁ is described as a tyre with a “descending” pattern. In this embodiment, k₁=NE₂/NE₁=2.

FIG. 5 depicts a frequency spectrum SFT of the noise generated by the indicators TUS₁ and TUS₂, namely the projections 18A et 18B associated with the second threshold S₂, which are visible in FIG. 3. A signal of the acoustic fingerprint noise generated by the indicators TUS₁ and TUS₂ is acquired, for example using a microphone. A Fourier transform is applied to the signal in order to obtain a raw frequency spectrum. Then, after steps of processing this raw frequency spectrum, notably steps of filtering, a filtered frequency spectrum is obtained. The frequency spectrum SFT of the noise as indicated in FIG. 5 is thus obtained, this comprising several elementary frequency components P1-P8. The spectrum has the form of a Dirac comb characterized by evenly distributed elementary frequency components. Each elementary frequency component is separated from the adjacent frequency component by a frequency distance F_{TUS} that is substantially constant. In this particular instance, F_{TUS}=120 Hz.

Parameters such as the number of wear indicators, the geometry at which they are embedded, the rotational speed of the tyre or the dimensions of the tyre define a reference frequency interval IR in which the frequency F_{TUS} is likely to belong. For a range of passenger-car tyres with circumferences in the range between 1.3 m and 3 m, a number of wear indicators that can range between 1 and 12 and a vehicle speed that can range between 10 km/h and 130 km/h, the frequency F_{TUS} may vary within the interval IR of between 1 and 278 Hz. The interval IR is similar for tyres of the heavy goods vehicle type.

FIG. 7 illustrates two frequency bands B1=[50 Hz; 79 Hz] and B2=[101 Hz; 159 Hz] that include F_{TUS} for the noise generated by the indicators TUS₁, TUS₂ respectively associated with each threshold S₁, S₂ for the tyre 10 of FIGS. 1 to 4 which has a running circumference of 1.93 m when new. As calculated above, k₁=NE₂/NE₁=2 so that the minimum value kₘᵢₙ of the values of kᵢ for iε[2, M] is equal to 2. For each threshold S₁, S₂, the acoustic fingerprint noise SFT emitted by the indicators TUS₁, TUS₂ is detected. In order unambiguously to identify the threshold Sᵢ associated with the noise generated by the tyre 10, the speed V for detecting the noise is limited to an interval I=[Vₘᵢₙ; Vₘₐₓ]=[70 km/h, 110 km/h] satisfying Vₘₐₓ≦kₘᵢₙ·Vₘᵢₙ. In such a case, the bands B1, B2 are separate, which means that, for a value of F_{TUS} determined from the acoustic fingerprint noise, it is possible unambiguously to identify which of the indicators is generating the corresponding noise and therefore which wear level has been reached.

FIG. 8 illustrates two bands B1=[36 Hz; 94 Hz] et B2=[72 Hz; 187 Hz]. In this case, the interval of speeds V in which the noise is detected is I=[Vₘᵢₙ; Vₘₐₓ]=[50 km/h; 130 km/h] and does not satisfy Vₘₐₓ≦kₘᵢₙ·Vₘᵢₙ. The bands B1, B2 have an interval of overlap [72 Hz; 94 Hz] such that, for values F_{TUS} in this interval of overlap, the corresponding noise is generated by the indicators without it being possible to identify which ones are generating the noise and therefore without it being possible to identify which wear level has been reached.

FIGS. 9 and 9A-9F depict a tyre according to a second embodiment. The tyre 10 is intended for a vehicle of the heavy goods vehicle type. Elements similar to those denoted in the preceding figures are denoted by identical references.

FIG. 9 depicts a development of the tread 12 of the tyre 10 according to the second embodiment of the invention.

Each set E₁-E₆ comprises a single acoustic wear indicator TUS₁-TUS₆ consisting of a projection 18A-18F.

Unlike the first embodiment, the tyre 10 according to the second embodiment comprises wear thresholds S₁-S₆ with NE₁=1, NE₂=2, NE₃=4, NE₄=8, NE₅=16 and NE₆=32 and therefore the following kᵢ ratios: k₂=k₃=k₄=k₅=k₆=NE₂/NE₁=NE₃/NE₂=NE₄/NE₃=NE₅/NE₄=NE₆/NE₅=2. As in the first embodiment, the tyre 10 has a “descending” noise pattern.

The depth of the grooves 16 is of the order of 14 millimetres, in this case 14.3 mm. The depth of each groove corresponding to the threshold SL is set at 2 mm, which corresponds to a threshold SL=12.3 mm.

The tyre 10 comprises sets E₃, E₄, E₅, E₆ of four other types of indicator TUS, denoted TUS₃, TUS₄, TUS₅, TUS₆, each one respectively corresponding to a predetermined wear threshold S₁, S₂, S₃, S₄ for the tyre 10. Each indicator TUS₃, TUS₄, TUS₅, TUS₆ is respectively constituted by a projection 18C-18F.

Each indicator TUS₁ associated with the threshold S₁ is also associated with the thresholds S₂-S₆ so as to generate an acoustic fingerprint noise when the thresholds S₂-S₆, have been exceeded; each indicator TUS₂ is associated with the thresholds S₂-S₆ so as to generate an acoustic fingerprint noise when the thresholds S₂-S₆, have been exceeded, each indicator TUS₃ is associated with the thresholds S₃-S₆ so as to generate an acoustic fingerprint noise when the thresholds S₃-S₆ have been exceeded, each indicator TUS₄ is associated with the thresholds S₄-S₆ so as to generate an acoustic fingerprint noise when the thresholds S₄-S₆, have been exceeded, each indicator TUS₅ is associated with the thresholds S₅ and S₆ so as to generate an acoustic fingerprint noise when the thresholds S₅ and S₆ have been exceeded and each indicator TUS₆ is associated only with the threshold S₆ so as to generate an acoustic fingerprint noise only when the threshold S₆ has been exceeded.

Each projection 18C-18F respectively has a height h₃, h₄, h₅ and h₆ which is predetermined when the tyre is new. h₁>h₂>h₃>h₄>h₅>h₆ and S₆>S₅>S₄>S₃>S₂>S₁ so that each projection of type 18A is associated with the thresholds S₁-S₆, each projection of type 18B is associated with the thresholds S₂-S₆, each projection of type 18C is associated with the thresholds S₃-S₆, each projection 18D is associated with the thresholds S₄-S₆, each projection 18E is associated with the thresholds S₅ and S₆ and each projection 18F is associated only with the threshold S₆. The first threshold S₁ corresponds substantially to 19% of the threshold SL, namely h₁=12 mm and S₁=2.3 mm. The second threshold S₂ corresponds substantially to 35% of the threshold SL, namely h₂=10 mm and S₂=4.3 mm. The third threshold S₃ corresponds substantially to 51% of the threshold SL, namely h₃=8 mm and S₃=6.3 mm. The fourth threshold S₄ corresponds substantially to 67% of the threshold SL, namely h₄=6 mm and S₄=8.3 mm. The fifth threshold S₅ corresponds substantially to 84% of the threshold SL, namely h₅=4 mm and S₅=10.3 mm. The sixth threshold S₆ corresponds substantially to 100% of the threshold SL, namely h₆=2 mm and S₆=12.3 mm.

The various thresholds correspond to various stages in the life of the tyre during which various actions need to be undertaken in order to spread the wear across the entire tread and thus lengthen the useful life of the tyre. Thus S₂ corresponds to wear for which the tyre can be swapped on the same axle. The threshold S₄ corresponds to wear for which the tyre can be turned around. The threshold S₅ corresponds to wear for which the tyre can be regrooved to restore its performance, notably its water drainage performance,

Just as in the first embodiment, the sets E₁-E₆ of indicators TUS₁-TUS₆ associated respectively with each threshold S₁-S₆, in this instance the projections 18A-18F, are evenly circumferentially distributed about the tyre 10. Further, all the sets E₁-E₆ are evenly distributed.

FIG. 10 illustrates six frequency bands B1=[5 Hz; 8 Hz], B2=[11 Hz; 16 Hz], B3=[22 Hz; 33 Hz], B4=[44 Hz; 66 Hz], B5=[88 Hz; 132 Hz] and B6=[176 Hz; 264 Hz] which include F_{TUS} for the noise generated by the indicators TUS₁-TUS₆ associated respectively with each threshold S₁-S₆ for the tyre 10 of the second embodiment which has a running circumference of 3.03 m in the new state. As calculated hereinabove, k₁=k₂=k₃=k₄=k₅=k₆=2 such that the minimum value kₘᵢₙ is equal to 2. For each threshold S₁-S₆, the acoustic fingerprint noise SFT emitted by the indicators TUS₁-TUS₆ is detected. In order unambiguously to identify the threshold Sᵢ associated with the noise generated by the tyre 10, the speed V is limited for noise detection to an interval I=[Vₘᵢₙ; Vₘₐₓ]=[60 km/h; 90 km/h] satisfying Vₘₐₓ≦kₘᵢₙ·Vₘᵢₙ. In this case, the bands B1-B6 are separate so that for a value of F_{TUS} determined from the acoustic fingerprint noise it is possible to identify unambiguously which indicators are generating the corresponding noise and therefore which wear threshold has been reached.

FIG. 11 illustrates two frequency bands six frequency bands B1=[3 Hz; 8 Hz], B2=[5 Hz; 16 Hz], B3=[11 Hz; 33 Hz], B4=[22 Hz; 66 Hz], B5=[44 Hz; 132 Hz] and B6=[88 Hz; 264 Hz]. In this case, the interval of speeds V in which the noise is detected is 1=[Vₘᵢₙ; Vₘₐₓ]=[50 km/h; 130 km/h] and does not satisfy Vₘₐₓ≦kₘᵢₙ·Vₘᵢₙ. The bands B1-B6 have intervals in which pairs overlap [5 Hz; 8 Hz], [11 Hz; 16 Hz], [22 Hz; 33 Hz], [44 Hz; 66 Hz] and [88 Hz; 132 Hz] such that for F_{TUS} values in these intervals of overlap, the corresponding noise is generated by indicators without it being possible to identify which are generating the noise and therefore without it being possible to identify which wear level has been reached.

FIG. 12 depicts a development of the tread 12 of a tyre 10 according to a third embodiment of the invention.

Unlike the tyre according to the first embodiment, each set E₁-E₂ comprises a single acoustic wear indicator TUS₁-TUS₆ consisting of a projection 18A-18F and all the projections 18A-18F are situated in the same grooves 16.

FIGS. 13 and 14 depict a fourth embodiment of the invention. Elements similar to those depicted in the preceding figures are denoted by identical references.

Unlike the tyres according to the preceding embodiments, each projection 18A of each indicator TUS₁ is immediately adjacent to a projection 18B of an indicator TUS₂.

With reference to FIG. 14, in which the tyre according to the fourth embodiment is depicted at a state of wear corresponding to the threshold S₁, the two indicators TUS₁ et TUS₂ therefore form a single wear indicator TUS consisting of a rubber projection 28 arranged at the bottom of the groove 16. The rubber projection 28 has a staircase overall shape and comprises first and second rubber parts 30, 32 respectively forming the projections 18A, 18B. Each first and second part 30, 32 respectively has a radially external surface 34, 36 intended to come into contact with the ground as the corresponding projection 18A, 18B passes through the contact area in which the tyre is contact with the ground. The radial dimension of the surface 34 is greater than the radial dimension of the surface 36. In other words, the height h₁ of the first part 30 is greater than the height h₂ of the second part 32.

FIGS. 15 and 16 depict a tyre according to a fifth embodiment of the invention. Elements similar to those depicted in the preceding figures are denoted by identical references.

Unlike the tyre according to the fourth embodiment, each projection 18A comprises an acoustic cavity 38 formed in the projection 18A. In this particular instance, the cavity 38 is formed in the second part 32 of the wear indicator TUS.

Beyond the threshold S₁ and, preferably, also beyond the threshold S₂, the acoustic cavity 38 is configured in such a way as to open radially towards the outside of the tyre 10 and so as to be closed by the ground in a substantially airtight manner as it passes through the contact area in which the tyre 10 is contact with the ground.

The invention is not limited to the embodiments described above.

The tread may comprise more than two grooves and therefore sets of indicators comprising more than two indicators that are substantially axially aligned, i.e. have the same azimuth position.

The tread may comprise several grooves and each indicator comprise a single projection so that two circumferentially successive indicators are situated in two different grooves.

The tread may comprise indicators arranged in each groove. Thus two indicators that are substantially axially aligned in pairs may have one single threshold in common or several.

In any event, the projections may have a variable or a constant contact cross section.

It is also possible to form a cavity in projections other than those of the indicators TUS₁ associated with the threshold S₁.

The features of the various embodiments described hereinabove may be combined provided that they are compatible with one another.

By way of additional examples of tyres with descending acoustic patterns, use may be made of tyres having three or four thresholds with the following characteristics:
NE₁=1, NE₂=2, NE₃=4, NE₄=8.
NE₁=1, NE₂=3, NE₃=6.
NE₁=1, NE₂=2, NE₃=6
NE₁=2, NE₂=4, NE₃=8.
NE₁=2, NE₂=6, NE₃=12.
NE₁=3, NE₂=6, NE₃=12.

1-24. (canceled)

25. A method for detecting wear of a tyre that includes at least two wear thresholds,
in which each wear threshold Sᵢ includes NEᵢ set(s) of at least one acoustic wear indicator associated with at least that wear threshold Sᵢ, each wear indicator structured to generate an acoustic fingerprint noise when the wear threshold Sᵢ has been exceeded, and
in which a number of set(s) of acoustic wear indicator(s) associated with each wear threshold is different from a number of set(s) of acoustic wear indicator(s) associated with each other wear threshold, with each wear indicator of each set being substantially axially aligned with each other wear indicator of that set when that set includes at least two wear indicators,
the method comprising steps of:
for each wear threshold Sᵢ, detecting an acoustic fingerprint noise generated by at least one wear indicator associated with that wear threshold at a speed V; and
limiting a value of the speed V for the step of detecting the acoustic fingerprint noise to an interval I=]Vₘᵢₙ; Vₘₐₓ] satisfying Vₘₐₓ≦kₘᵢₙ·Vₘᵢₙ,
wherein, for each wear threshold Sᵢ, kₘᵢₙ is a minimum value of values of kᵢ for iε[2, M] where M is a total number of the wear thresholds, with:
kᵢ=NEᵢ/NEᵢ₋₁ when for a value of iε[2, M], NEᵢ/NEᵢ₋₁>1, or
kᵢ=NEᵢ₋₁/NEᵢ when for a value of iε[2, M], NEᵢ₋₁/NEᵢ>1.

26. The method according to claim 25, wherein the acoustic fingerprint noise includes a plurality of elementary acoustic fingerprint frequency components.

27. The method according to claim 26, wherein the plurality of elementary acoustic fingerprint frequency components form at least part of a Dirac comb.

28. The method according to claim 26, wherein each elementary frequency component of the acoustic fingerprint noise is separated from at least one adjacent elementary frequency component of the acoustic fingerprint noise by a frequency difference contained within a reference frequency interval associated with only one of the wear thresholds.

29. The method according to claim 28, wherein the reference frequency interval is predetermined and contained between 1 and 300 Hz.

30. The method according to claim 25, wherein each set includes only one wear indicator.

31. The method according to claim 25, wherein each set includes at least two wear indicators.

32. The method according to claim 25, wherein the set or sets of wear indicator(s) associated with each wear threshold is or are evenly distributed circumferentially about the tyre.

33. The method according to claim 25,
wherein, when the tyre is new, the tyre has no cavity delimited by two ribs that are formed transversely to a bottom portion of a groove of predetermined height, the predetermined height being substantially equal to a difference between a predetermined depth of the groove and one of the wear thresholds, and
wherein a distance separating the two ribs is less than a distance that is predetermined such that, when wear of the tyre exceeds each wear threshold, a cavity formed by the groove and the two ribs is an acoustic cavity.

34. The method according to claim 25, wherein each wear indicator includes a projection of rubber extending radially from a bottom portion of a circumferential groove of the tyre, the projection being designed to come into contact with a ground surface as the projection passes through a contact area in which the tyre makes contact with the ground surface once a wear threshold associated with the wear indicator has been exceeded.

35. The method according to claim 34, wherein the projections are arranged such that, regardless of a degree of wear of the tyre, a groove and two circumferentially successive projections of the groove delimit a space that is open to air as the two projections pass through the contact area in which the tyre makes contact with the ground surface.

36. The method according to claim 34, wherein, when the tyre is new, each circumferential groove has a predetermined depth, and a height of each projection of each wear indicator is substantially equal to a difference between the predetermined depth of the groove and a wear threshold associated with that wear indicator.

37. The method according to claim 34, wherein each projection includes at least one cavity formed therein, the cavity being shaped in such a way that, when a wear threshold associated with a wear indicator that includes the projection has been exceeded, the cavity:
opens radially to outside of the tyre, and
is closed by the ground surface in a substantially airtight manner as the cavity passes through the contact area in which the tyre makes contact with the ground surface.

38. The method according to claim 34, wherein each projection of each wear indicator associated with a wear threshold is circumferentially separated from each projection of each wear indicator associated with each other wear threshold.

39. The method according to claim 34, wherein each projection of each wear indicator associated with a wear threshold is immediately adjacent to a projection of a wear indicator associated with another wear threshold.

40. The method according to claim 25, wherein kᵢ=NEᵢ/NEᵢ₋₁>1 for any value of iε[2, M].

41. The method according to claim 25, wherein each wear indicator associated with a given wear threshold is also associated with a wear threshold above the given wear threshold.

42. The method according to claim 25, wherein kᵢ=NEᵢ₋₁/NEᵢ>1 for any value of iε[2, M].

43. The method according to claim 25, further comprising steps of:
acquiring a signal of the acoustic fingerprint noise of the tyre at the speed V;
applying a Fourier transform to the signal in order to obtain a raw frequency spectrum;
processing the raw frequency spectrum to obtain a filtered frequency spectrum containing equally distributed elementary frequency components in which each frequency component is separated from an adjacent frequency component by a substantially constant frequency difference; and
unambiguously identifying that a wear threshold has been reached based on the frequency difference.

44. The method according to claim 25,
wherein, for each wear threshold, a frequency difference of a frequency spectrum that corresponds to the acoustic fingerprint noise is predetermined for each value Vₘᵢₙ, Vₘₐₓ of an interval I in order to obtain a frequency difference band corresponding to that wear threshold, and
wherein wear is detected only when the tyre is at the speed V such that each frequency difference band of each wear threshold is separated from a frequency difference band or frequency bands of each other wear threshold.

45. The method according to claim 25, wherein Vₘₐₓ<0.99·kₘᵢₙ·Vₘᵢₙ.

46. The method according to claim 25, wherein Vₘₐₓ<0.9·kₘᵢₙ·Vₘᵢₙ.

47. A non-transitory computer-readable storage medium storing a program that, when executed by a computer, performs a method for detecting wear of a tyre that includes at least two wear thresholds,
in which each wear threshold Sᵢ includes NEᵢ set(s) of at least one acoustic wear indicator associated with at least that wear threshold Sᵢ, each wear indicator structured to generate an acoustic fingerprint noise when the wear threshold Sᵢ has been exceeded, and
in which a number of set(s) of acoustic wear indicator(s) associated with each wear threshold is different from a number of set(s) of acoustic wear indicator(s) associated with each other wear threshold, with each wear indicator of each set being substantially axially aligned with each other wear indicator of that set when that set includes at least two wear indicators,
the method comprising steps of:
for each wear threshold Sᵢ, detecting an acoustic fingerprint noise generated by at least one wear indicator associated with that wear threshold at a speed V; and
limiting a value of the speed V for the step of detecting the acoustic fingerprint noise to an interval I=]Vₘᵢₙ; Vₘₐₓ] satisfying Vₘₐₓ≦kₘᵢₙ·Vₘᵢₙ,
wherein, for each wear threshold Sᵢ, kₘᵢₙ is a minimum value of values of kᵢ for iε[2, M] where M is a total number of the wear thresholds, with:
kᵢ=NEᵢ/NEᵢ₋₁ when for a value of iε[2, M], NEᵢ/NEᵢ₋₁>1, or
kᵢ=NEᵢ₋₁/NEᵢ when for a value of iε[2, M], NEᵢ₋₁/NEᵢ>1.

48. A method for detecting wear of a tyre that includes at least two wear thresholds,
in which each wear threshold Sᵢ includes NEᵢ set(s) of at least one acoustic wear indicator associated with at least that wear threshold Sᵢ, each wear indicator structured to generate an acoustic fingerprint noise when the wear threshold Sᵢ has been exceeded, and
in which a number of set(s) of acoustic wear indicator(s) associated with each wear threshold is different from a number of set(s) of acoustic wear indicator(s) associated with each other wear threshold, with each wear indicator of each set being substantially axially aligned with each other wear indicator of that set when that set includes at least two wear indicators,
the method comprising a step of providing, from a non-transitory computer-readable storage medium, a program that, when executed by a computer:
performs a detection in which, for each wear threshold Sᵢ, an acoustic fingerprint noise generated by at least one wear indicator associated with that wear threshold at a speed V is detected; and,
for the detection, limits a value of the speed V to an interval I=]Vₘᵢₙ; Vₘₐₓ] satisfying Vₘₐₓ≦kₘᵢₙ·Vₘᵢₙ,
wherein, for each wear threshold Sᵢ, kₘᵢₙ is a minimum value of values of kᵢ for iε[2, M] where M is a total number of the wear thresholds, with:
kᵢ=NEᵢ/NEᵢ₋₁ when for a value of iε[2, M], NEᵢ/NEᵢ₋₁>1, or
kᵢ=NEᵢ₋₁/NEᵢ when for a value of iε[2, M], NEᵢ₋₁/NEᵢ>1.
